(19) United States
(12) Patent Application Publication
(10) Pub. No.: US 2010/0066644 A1
(43) Pub. Date: Mar. 18, 2010

(54) Heads up projection system for handheld devices with displays

(76) Inventor: Farid Souluer, Chester Springs, PA (US)

Correspondence Address: HARDING, EARLEY, FOLLMER & FRAILEY, 86 THE COMMONS AT VALLEY FORGE, 1288 VALLEY FORGE ROAD, P. O. BOX 750, VALLEY FORGE, PA, 19482-0750, US

(21) Appl. No.: 12/459,392

(22) Filed: Jun. 30, 2009

Related U.S. Application Data
(60) Provisional application No. 61/076,758, filed on Jun. 30, 2008.

(51) Int. Cl. G09G 5/00; H04M 1/00; G03B 21/00

(52) U.S. Cl. 345/7; 455/556.1; 353/119

(57) ABSTRACT

A system for projecting a display image from a handheld portable device having a display, such as a cell phone or a GPS device, the system including a housing for containing one or more components, a high intensity light source located adjacent to the display and disposed to emit light through the display, a lens located adjacent to the display and adapted to pass the light emitted from the light source through the display onto an object, where cell phone, GPS device, or handheld portable electronic device components that are normally necessary to operate said cell phone, GPS device or handheld portable electronic device and operably configure to provide a display image. The System may be operated as desired to generate a display image on the display of the handheld portable device, and to project that display image onto another surface, such as a vehicle windshield screen or wall. A powering means for powering the components also may be provided.

### BACKGROUND OF INVENTION

1. Field of the Invention

The present invention relates to cell phone technology and other small device technology such as portable navigation devices, and more particularly concerns systems for providing the display from said portable devices onto windshields of cars.

2. Brief Description of Prior Art

Cell phones, PDA's, GPS units and other hand held devices having displays are commonly used in the automobile. However due to current sizes of the hand held portable devices, the displays are often difficult to see given their small size. There is a need for the electronic devices to be portable, hand held and easily carried around. Accordingly, it is desirable to maximize the visual display available from a hand held portable electronic device.

### SUMMARY OF THE INVENTION

It is an object of this invention to provide a means for displaying information that is normally displayed on a hand held, portable device, such as a cell phone, PDA or GPS device, onto a larger area where the image can be easier to view.

It is another object of the invention to provide a display means that is portable along with the portable hand held device.

These objects and other objects are accomplished by my invention which is described below.

### BRIEF DESCRIPTION OF THE DRAWING

FIG. 1 is an exploded schematic view showing components of a system for projecting a display image from a hand held portable device such as a cell phone or GPS onto a surface such as a windshield or screen or a wall.

FIG. 2 is a schematic view of the high intensity LED display for use in hand held portable devices such as cell phones or GPS devices in conjunction with a lens for displaying the image on a larger surface such as a windshield or screen or a wall.

FIG. 3 is a schematic of the display circuitry functions for a portable hand held device such as a cell phone or GPS device connected with a high intensity LED.

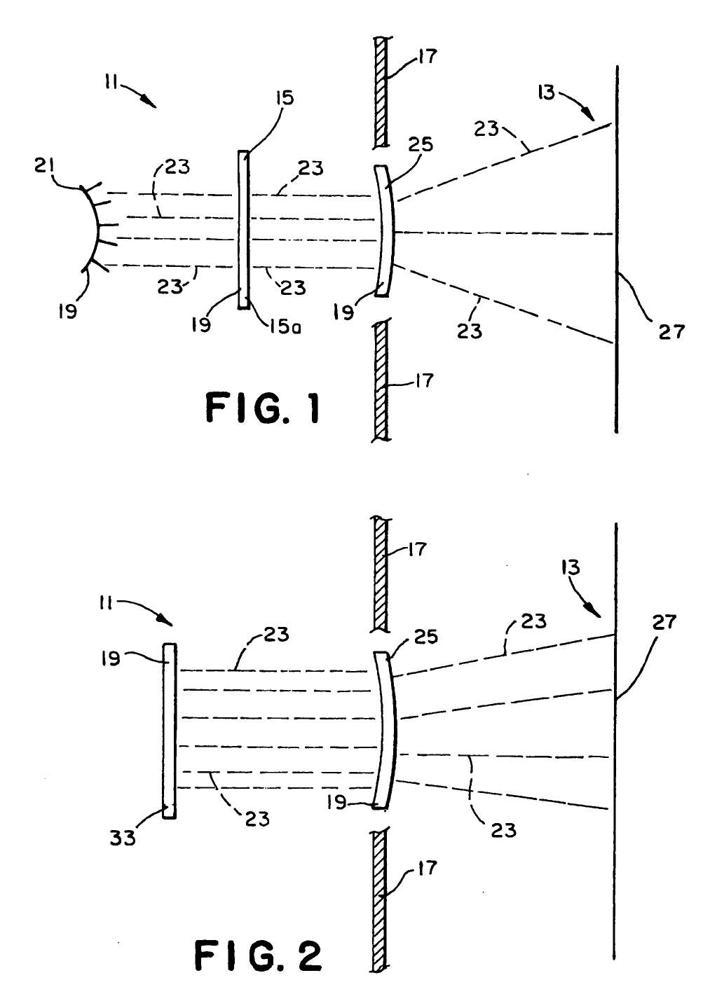

### DETAILED DESCRIPTION OF THE INVENTION

Turning to the drawings, there is illustrated a system 11 for projecting a display image 13 from a hand held portable device, the system having a display 15 for showing a display image 13 of a device such as a cell phone or GPS. The device preferably has a housing 17 for containing one or more components 19. The components 19 may include circuitry used in a cell phone or GPS device, such as telecommunications and satellite communications components. The system 11 further includes a high intensity light source 21 located adjacent to the display 15 and disposed to admit light 23 through the display 15. The system further includes a lens 25 located adjacent to the display 15 and adapted to pass the light 23 admitted from the light source 21 through the display 15 onto an object 27. The object 27, according to a preferred arrangement, may be a windshield of a car, a wall, screen or other surface capable of displaying the image when light is projected on it. The system 11 further includes, contained within the housing 17, a cell phone, GPS device, or hand held portable electronic device components 19, which are normally necessary to operate the cell phone, GPS device, or hand held portable electronic device. The system 11 further includes powering means 29 for powering one or more components, wherein the cell phone, GPS device, or hand held portable electronic device components 19 are powered by the powering means 29 and operate as desired to generate a display image 15a on the display 15. The display image 15a appearing on the display 15 is cast by the light 23 from the light source 21 through the lens 25 onto the object 27.

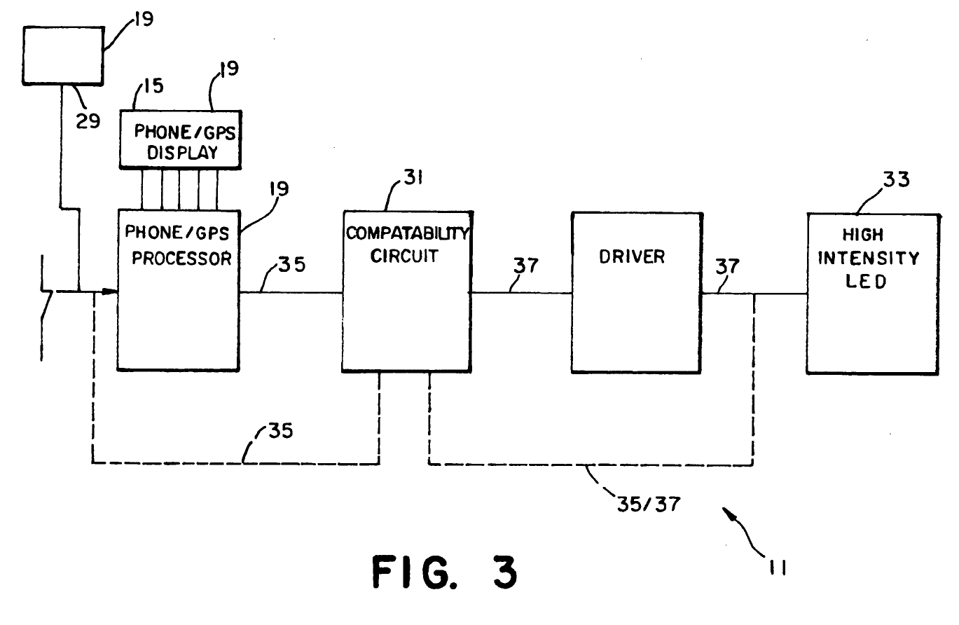

Turning to FIGS. 2 and 3, there is shown a system 11 for projecting a display image 13 from a hand held, portable device having a display 15 for showing a display image 13. The hand held portable device, for example, may be a cell phone or GPS device. The system preferably includes a housing 17 for containing one or more components 19, including one or more cell phone, GPS device or hand held portable electronic device components 19, which are normally necessary to operate said cell phone, GPS device or hand held portable for its intended purpose, including the display. The system 11 further includes a compatibility circuit 31 connected to the one or more cell phone, GPS device or hand held portable device components 19 and being connected to a high intensity, tri-colored LED display 33 for accessing image data 35 for use with the display 15 and, if necessary, manipulating the image data 35 in, or creating a second image data 37 that is capable of operating, the high intensity tri-colored LED display 33 to reproduce the display image 23 projected through the lens 25 onto an object 27.

The embodiments discussed herein are not intended to be limiting and the inventive articles and methods disclosed herein are not intended to be exhausted or to limit the invention to the precise form discussed above. While specific embodiments of, and examples for, the invention are described herein for illustrative purposes, various equivalent modifications are possible within the scope of the invention, as those skilled in the relevant art will recognize.

What is claimed is:

1. An integral display projection system for a handheld portable device comprising:
a housing for containing one or more operative components for a cell phone, PDA, or a handheld GPS device,
an LCD matrix,
components of a cell phone, PDA, or a handheld GPS device,
powering means,
a lens, and
a driver for reading data provided to the conventional display processor or the conventional display.

2. The integral display projection system of claim 1, including circuitry for manipulating the output of the image from the one or more operative components of a cell phone, PDA or handheld GPS device for transmission and display on a high intensity tri-color LED display.

3. The integral display projection system of claim 2, wherein said circuitry is configured to provide a second image data that appears on a said high intensity tri-color LED display that corresponds to said image generated on said display of a cell phone, PDA or handheld device.

4. A system for projecting a display image from a handheld portable device having a display for showing a display image such as a cell phone or a GPS device, the system comprising:
a housing for containing one or more components,
a high intensity light source located adjacent to the display and disposed to emit light through said display,
a lens located adjacent to the display and adapted to pass the light emitted from the light source through said display onto an object,
cell phone, GPS device, or handheld portable electronic device components which are normally necessary to operate said cell phone, GPS device or handheld portable electronic device, and
powering means for powering one or more components,
wherein the cell phone, GPS device, or handheld portable electronic device components are powered by the powering means and maybe operated as desired to generate a display image on the display of the handheld portable device, and wherein the display image on the display is cast by the light from said high intensity light source passing through the lens onto the object.

5. A system for projecting a display image from a handheld, portable device having a display for showing a display image such as a cell phone or a GPS device, the system comprising:
a housing for containing one or more components,
one or more cell phone, GPS device or handheld portable electronic device components, which are normally necessary to operate said cell phone, GPS device, or handheld portable device for its intended purpose including the display, and
a compatibility circuit connected to the one or more cell phone, GPS device, or handheld portable electronic device components and connected to a high intensity tri-color led display for accessing image data for use with the display, and if necessary, manipulating the image data, and/or creating second image data that is capable of operating the high intensity tri-color led matrix to reproduce the display image lens.
